(19) United States
(12) Patent Application Publication
(10) Pub. No.: US 2012/0127261 A1
(43) Pub. Date: May 24, 2012

(54) TELECONFERENCING DEVICE AND IMAGE DISPLAY PROCESSING METHOD

(75) Inventor: Susumu Okada, Kanagawa (JP)

(73) Assignee: PANASONIC CORPORATION, Osaka (JP)

(21) Appl. No.: 13/377,695

(22) PCT Filed: May 21, 2010
(86) PCT No.: PCT/JP2010/003436

§ 371 Date: Jan. 26, 2012

(30) Foreign Application Priority Data
Jul. 14, 2009 (JP) 2009-165922

(51) Int. Cl. H04N 7/14

(52) U.S. Cl. 348/14.08; 348/E07.078

(57) ABSTRACT

A teleconferencing device includes an image receiving section which receives images from corresponding base, a zoom magnification setting receiving section which receives zoom magnification setting information of a camera of the corresponding base, an image enlargement and reduction ratio derivation section which derives an enlargement or reduction ratio, at which each subject in an image captured by each camera of the corresponding base is displayed on a display of a host base in life-size, on the basis of the zoom magnification setting information and screen size information of the display of the host base, an image enlargement and reduction section which enlarges or reduces the image transmitted from the corresponding base on the basis of the enlargement or reduction ratio, and an image display control section which performs control such that the enlarged or reduced image from each corresponding base is displayed on the display of the host base.

### TECHNICAL FIELD

The present invention relates to a teleconferencing device which transmits and receives images captured by cameras and displays images to perform communication with a person at a remote location, and to an image display processing method.

### BACKGROUND ART

In recent years, with the organization of the infrastructure of an IP network, the introduction of a teleconferencing device in which data, such as images or sound, is transmitted to a remote base through the IP network and displayed is advancing. With the propagation of a large-screen television, such as a plasma display, a teleconferencing system in which the zoom magnification of a camera is adjusted to set such that an image of a subject is viewed on the screen of a corresponding base in life-size is also considered. According to this teleconferencing system, realistic sensation is obtained as if any other party of a teleconference is right in front of his/her eyes.

In a teleconferencing system described in PTL 1, a projector, a camera, and the seating position of a person serving as a subject are fixed, and the zoom magnification of the camera and the display magnification of the projector are set. Thus, in the teleconferencing system described in PTL 1, the person serving as a subject can be displayed on a screen to be irradiated by a projector on the corresponding base side at the time of a teleconference in life-size.

### CITATION LIST

### Patent Literature

PTL 1: JP-A-8-32948
PTL 2: JP-A-10-302046

### SUMMARY OF INVENTION

### Technical Problem

In the bases which execute a teleconferencing system, display apparatuses which are different in the screen size, such as displays, may be used. In this case, in order that an image of a subject on a host base (first base) side is displayed on the screen of a display apparatus provided in a corresponding base (second base) in life-size, the following operation should be performed. That is, a user on the second base side should set the zoom magnification of the camera provided in the first base by a remote operation. Alternatively, the user on the first base side should adjust the zoom magnification of the camera provided in the first base in accordance with an instruction from the second base side through a remote communication unit, such as a teleconference or a telephone.

In order to realize the teleconferencing system described in PTL 1, it is necessary to provide a system in which all the bases involving in a teleconference are constituted by the same apparatus.

An object of the invention is to provide a teleconferencing device capable of displaying a subject captured by each camera of a corresponding base on each display provided in a host base in life-size without depending on the screen size of the display provided in each base, and an image display processing method.

### Solution to Problem

The invention provides a teleconferencing device for a teleconferencing system which transmits and receives an image captured by a camera between a host base and at least one corresponding base, and displays the images on a display. The teleconferencing device includes an image receiving section that receives an image transmitted from the corresponding base; a zoom magnification setting receiving section that receives zoom magnification setting information of each camera provided in the corresponding base; an image enlargement and reduction ratio derivation section that derives an enlargement or reduction ratio, at which each subject in the image captured by each camera of the corresponding base is displayed on the display provided in the host base in life-size, for each corresponding base on the basis of the zoom magnification setting information received by the zoom magnification setting receiving section and screen size information of the display provided in the host base; an image enlargement and reduction section that enlarges or reduces the image transmitted from the corresponding base on the basis of the enlargement or reduction ratio; and an image display control section that conducts a control to display the image from each corresponding base enlarged or reduced by the image enlargement and reduction section on the display of the host base.

The invention also provides an image display processing method which is executed by a teleconferencing device for a teleconferencing system which transmits and receives an image captured by a camera between a host base and at least one corresponding base and displays the image on a display. The method includes receiving an image transmitted from the corresponding base; receiving zoom magnification setting information of each camera provided in the corresponding base; deriving an enlargement or reduction ratio, at which each subject in the image captured by each camera of the corresponding base is displayed on the display provided in the host base in life-size, for each corresponding base on the basis of the zoom magnification setting information and screen size information of the display provided in the host base; enlarging or reducing the image transmitted from the corresponding base on the basis of the enlargement or reduction ratio; and conducting a control to display the enlarged or reduced image from each corresponding base on the display of the host base.

### Advantageous Effects of Invention

According to the teleconferencing device and the image display processing method of the invention, even when the display provided in each base is different in the screen size, the image of the subject captured by the camera of the corresponding base can be displayed on the display provided in the host base in life-size. That is, the subject captured by each camera provided in the corresponding base can be displayed on the display provided in the host base in life-size. Therefore, the users of the teleconferencing device can have a teleconference with realistic sensation as if all the users are present on the host base. The number of bases is not limited to two, and even when the number of bases is three or more, the same effects can be obtained.

### BRIEF DESCRIPTION OF DRAWINGS

FIG. 1 is a block diagram showing an example of the configuration of a teleconferencing system including a teleconferencing device of an embodiment.

FIG. 2 is a block diagram showing the internal configuration of a teleconferencing device of an embodiment.

FIG. 3(a) is a diagram showing the size relationship between an enlarged image and the screen of a display, and FIG. 3(b) is a diagram showing the size relationship between an enlarged image, a processed image, and the screen of a display.

FIGS. 4(a) to 4(c) are diagrams showing an example of the relationship between the position of a face of a subject in an enlarged image and a truncated region of image data.

FIG. 5(a) is a diagram showing the size relationship between a reduced image and the screen of a display, and FIG. 5(b) is a diagram showing the size relationship between a reduced image, a processed image, and the screen of a display.

FIGS. 6(a) to 6(c) are diagrams showing an example of the relationship between the position of a face of a subject in a reduced image and an added region of image data.

FIG. 7 is a flowchart showing an operation when a teleconferencing device 100 shown in FIG. 2 displays an image on a display 130.

FIG. 8 is a block diagram showing a teleconferencing system in which teleconferencing devices 100 of three bases A to C are connected together through a network 120.

FIG. 9(a) is a diagram showing an example where an image processing section 131 displays an image, in which black image data is added on the circumference of a reduced image, on a display 130, and FIG. 9(b) is a diagram showing an example where the image processing section 131 displays an image, in which image data on the circumference of a reduced image is processed, on the display 130.

FIG. 10(a) is a diagram showing an example of an image, and FIG. 10(b) is a diagram showing regions when an image is segmented.

FIG. 11 is a diagram showing an example of a segment-extended image.

FIG. 12 is a flowchart showing the operation of the image processing section 131 described with reference to FIGS. 9 to 11.

### DESCRIPTION OF EMBODIMENTS

Hereinafter, an embodiment of the invention will be described with reference to the drawings.

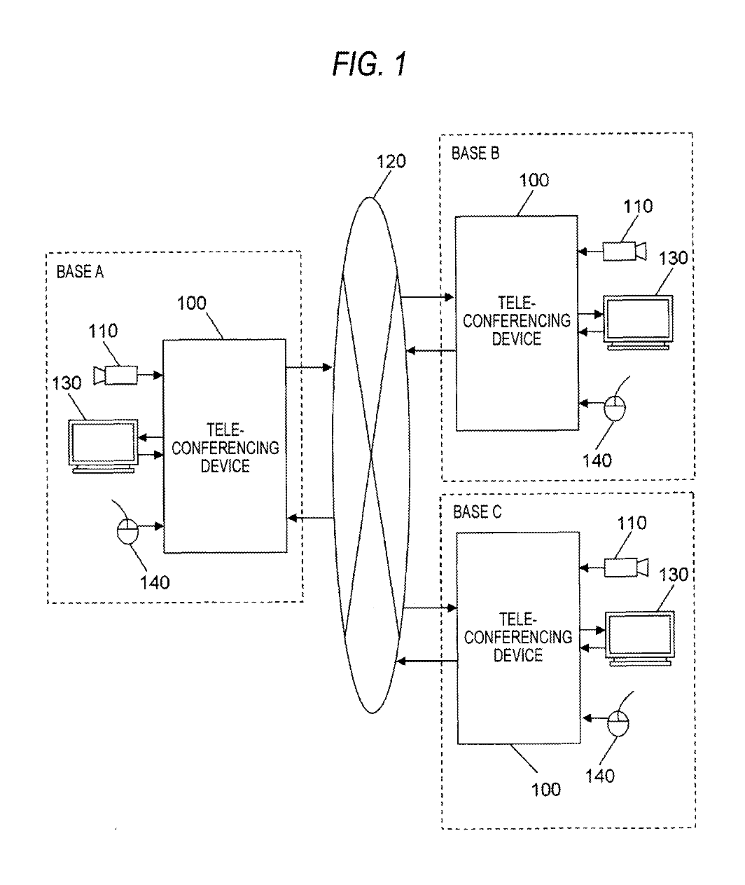

FIG. 1 is a block diagram showing an example of the configuration of a teleconferencing system including a teleconferencing device of an embodiment. In the teleconferencing system shown in FIG. 1, teleconferencing devices 100 provided in three bases A to C are connected together through a network 120. The number of bases is not limited to three, and may be two or more.

A camera 110, a display 130, and an input device 140 are connected to the teleconferencing device 100 of each base. The camera 110 captures an image of a person who is in each base. The camera 110 stores zoom magnification setting information. The teleconferencing device 100 transmits data of an image captured by the camera 110 to the teleconferencing device of the corresponding base through the network 120. The teleconferencing device 100 receives data transmitted from the teleconferencing devices of the corresponding base through the network 120. The display 130 displays images of data received by the teleconferencing device 100. The input device 140 is an input interface, such as a mouse or a remote controller, which is used when the user inputs the conditions or the like to be set in the teleconferencing device 100.

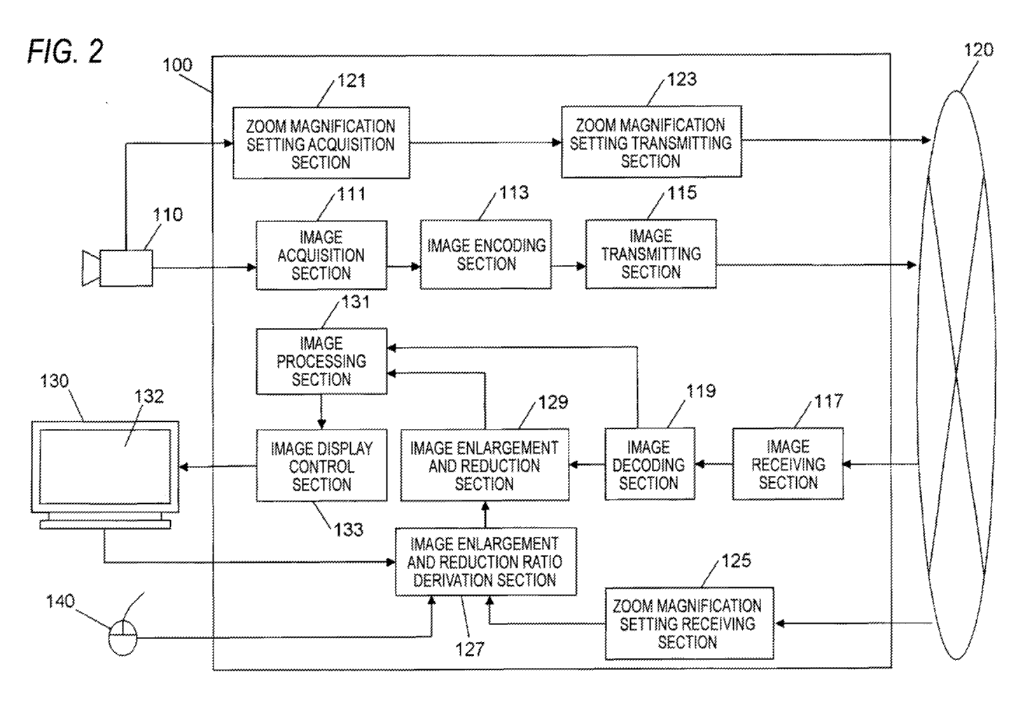

FIG. 2 is a block diagram showing the internal configuration of a teleconferencing device of an embodiment. As shown in FIG. 2, a teleconferencing device of a first embodiment includes an image acquisition section 111, an image encoding section 113, an image transmitting section 115, an image receiving section 117, an image decoding section 119, a zoom magnification setting acquisition section 121, a zoom magnification setting transmitting section 123, a zoom magnification setting receiving section 125, an image enlargement and reduction ratio derivation section 127, an image enlargement and reduction section 129, an image processing section 131, and an image display control section 133.

The image acquisition section 111 acquires data of an image of a subject in the host base captured by the camera 110. The image encoding section 113 encodes image data acquired by the image acquisition section 111 in a format to be transmitted to a network. The image encoding section 113 may change the resolution of the image depending on the transmission band situation of the network 120 and may perform encoding. For example, when the transmission band of the network 120 is narrow, the image encoding section 113 converts the image captured by the camera 110 to an image having low resolution and then performs encoding.

The image transmitting section 115 transmits image data (encoded image data) encoded by the image encoding section 113 to the teleconferencing device of the corresponding base through the network 120. Encoded image data to be transmitted by the image transmitting section 115 may include information (image resolution information) representing the resolution of the image. In this case, when encoding image data, the image encoding section 113 includes the image resolution information in encoded image data.

The image receiving section 117 receives encoded image data transmitted from the teleconferencing device of another base through the network 120. The image decoding section 119 decodes encoded image data and sends image data in a format to be displayed on the display 130 to the image enlargement and reduction section 129. When the image resolution information is included in encoded image data received by the image receiving section 117, the image decoding section 119 sends the image resolution information to the image enlargement and reduction ratio derivation section 127.

The zoom magnification setting acquisition section 121 acquires the zoom magnification setting information of the camera 110. Although in this embodiment, the camera 110 stores the zoom magnification setting information, the teleconferencing device 100 may store the zoom magnification setting information in a memory (not shown). In this case, when the user of each base installs the teleconferencing device 100 and the camera 110 or when the user sets the zoom magnification of the camera 110, the user sets the zoom magnification by the input device 140.

The zoom magnification setting information is information representing the size of a subject with respect to the size of a display, unlike a zoom magnification expression of a general camera, for example, 50 mm in 35 mm equivalent, or the like. For example, the zoom magnification setting information is expressed as “life-size in a 50-inch display”, “half life-size in a 42-inch display”, or the like.

The size of the subject represented in the zoom magnification setting information may be represented by the size of a specific body site, not the ratio with respect to life-size. For example, the zoom magnification setting information may be expressed as “the size of a face in a vertical direction is 10 cm in a 50-inch display”, “a shoulder-width is 30 cm in a 42-inch display”, or the like. In this case, the image enlargement and reduction ratio derivation section 127 calculates the ratio of life-size on the basis of average size data of a body site represented by the zoom magnification setting information.

The zoom magnification setting transmitting section 123 sends the zoom magnification setting information acquired by the zoom magnification setting acquisition section 121 to the teleconferencing device of the corresponding base through the network 120. For example, at the time of call control in which the teleconferencing device 100 which starts a teleconference establishes the connection to the teleconference terminal of the corresponding base, the zoom magnification setting transmitting section 123 sends the zoom magnification setting information together with connection information including an image data compression format, transmission rate, and the like.

The zoom magnification setting receiving section 125 receives the zoom magnification setting information transmitted from the teleconferencing device of another base through the network 120. The zoom magnification setting receiving section 125 sends the zoom magnification setting information to the image enlargement and reduction ratio derivation section 127 without delay.

The image enlargement and reduction ratio derivation section 127 derives a ratio (enlargement or reduction ratio), in which the image enlargement and reduction section 129 enlarges or reduces an image, on the basis of the zoom magnification setting information received by the zoom magnification setting receiving section 125 and screen size information of the display 130. The image enlargement and reduction ratio derivation section 127 derives the enlargement or reduction ratio such that a subject captured by the camera 110 of the corresponding base can be displayed on the display 130 of the host base in life-size. The details of the method of deriving the enlargement or reduction ratio will be described below.

With regard to the screen size information of the display 130, the image enlargement and reduction ratio derivation section 127 acquires the screen size information from the display 130, or the user inputs the screen size information to the image enlargement and reduction ratio derivation section 127 by the input device 140. The screen size information of the display 130 includes information regarding “inch” representing the size of a screen 132 of the display 130 and resolution information regarding the number of pixels in each of the vertical and horizontal directions of the screen 132 (the number of vertical pixels×the number of horizontal pixels).

The image enlargement and reduction section 129 performs data process for enlarging or reducing the size of an image of image data sent from the image decoding section 119 on the basis of the enlargement or reduction ratio derived by the image enlargement and reduction ratio derivation section 127. The image enlargement and reduction section 129 sends data of the enlarged or reduced image to the image processing section 131.

The image processing section 131 performs image data processing which is required when the image enlargement and reduction section 129 enlarges or reduces an image. The details of image processing which is performed by the image processing section 131 will be described below. The image display control section 133 performs control such that an image processed by the image processing section 131 is displayed on the display 130.

Hereinafter, the method of deriving the enlargement or reduction ratio by the image enlargement and reduction ratio derivation section 127 will be described in detail. In the following description, it is assumed that the resolution (image resolution) of an image received by the image receiving section 117 is the same as the resolution (display resolution) of the display 130.

When the screen size information of the display 130 represents “x-inch”, and the zoom magnification setting information represents “life-size in a y-inch display”, the image enlargement and reduction ratio derivation section 127 derives an enlargement or reduction ratio p by Expression (1).

$$\begin{matrix}[ Equation 1 ] & \\ p = \frac{y}{x} & ( 1 )\end{matrix}$$

Thus, when the screen size of the display 130 is “50-inch”, and the zoom magnification setting information is “life-size in a 42-inch display”, the image enlargement and reduction ratio derivation section 127 derives the enlargement or reduction ratio p of 0.84 (=42/50) times. In this case, since the enlargement or reduction ratio p is smaller than 1, the image enlargement and reduction section 129 reduces an image. When the enlargement or reduction ratio p is greater than 1, the image enlargement and reduction section 129 enlarges an image.

A function of enlarging or reducing and displaying an image having resolution different from the set resolution may be set in the display 130. In this case, even when an image obtained by enlarging or reducing the image on the basis of the enlargement or reduction ratio p is displayed on the display 130, a subject on the corresponding base side cannot be displayed in life-size. Accordingly, when the resolution (image resolution) of an image received by the image receiving section 117 is different from the resolution (display resolution) of the display 130, the enlargement or reduction ratio is derived with reference to the resolution too. Specifically, the image enlargement and reduction ratio derivation section 127 derives the enlargement or reduction ratio with reference to the image resolution and the display resolution in addition to the zoom magnification setting information and the screen size information of the display 130.

The image enlargement and reduction ratio derivation section 127 derives an enlargement or reduction ratio p′ by Expression (2) on the basis of the screen sizes x and y. In Expression (2), it is assumed that the image resolution and the display resolution have the same aspect ratio (the aspect ratio of the screen), the resolution in the vertical direction of the image resolution is m, and the resolution in the vertical direction of the display resolution is n. For example, if x=50, y=42, m=1080, and n=720, the enlargement or reduction ratio p′becomes 0.56.

$$\begin{matrix}[ Equation 2 ] & \\ {p}^{′} = \frac{y}{x} \times \frac{n}{m} & ( 2 )\end{matrix}$$

Hereinafter, image processing which is performed by the image processing section 131 will be described in detail. In the following description, the resolution (image resolution) of an image received by the image receiving section 117 is the same as the resolution (display resolution) of the display 130.

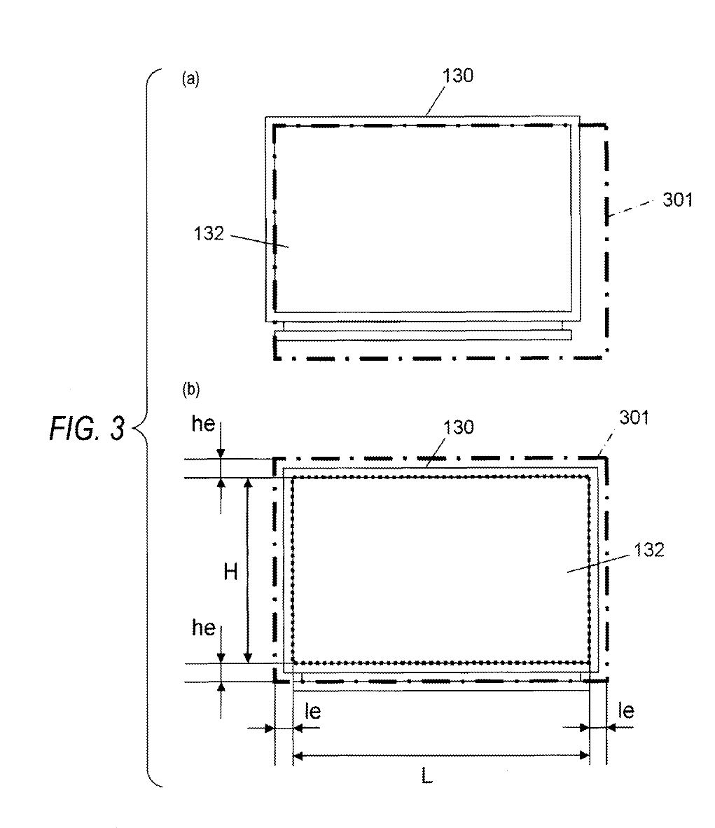

First, image processing when the image enlargement and reduction section 129 enlarges an image will be described. FIG. 3(a) is a diagram showing the size relationship between an enlarged image and the screen of a display. FIG. 3(b) is a diagram showing the size relationship between an enlarged image, a processed image, and the screen of a display.

An image enlarged by the image enlargement and reduction section 129 cannot be displayed on the display 130 as it is. That is, as shown in FIG. 3(a), an enlarged image 301 protrudes from the screen 132 of the display 130. Accordingly, the image processing section truncates the circumferential portion of the enlarged image 301 to adjust the image to the size of the screen 132 of the display 130. For example, as shown in FIG. 3(b), the image processing section 131 truncates image data for he pixels from the upper and lower side of the enlarged image 301 and truncates image data for le pixels from the left and right sides of the enlarged image 301.

When the size of the screen 132 of the display 130 is “vertical H pixels×horizontal L pixels”, he is expressed by Expression (3), and le is expressed by Expression (4). p is the above-described enlargement or reduction ratio.

$$\begin{matrix}[ Equation 3 ] & \\ he = \frac{( p - 1 )}{2 H} & ( 3 ) \\ [ Equation 4 ] & \\ le = \frac{( p - 1 )}{2 L} & ( 4 )\end{matrix}$$

A subject is not limited as being in the center of the image. For this reason, as described above, if image data is truncated evenly from the upper and lower sides or from the left and right sides, there is a situation where the face of the subject is not displayed on the display 130. Accordingly, the image processing section 131 may determine a region where image data will be truncated in accordance with the position of the face in the enlarged image detected by a face detection function.

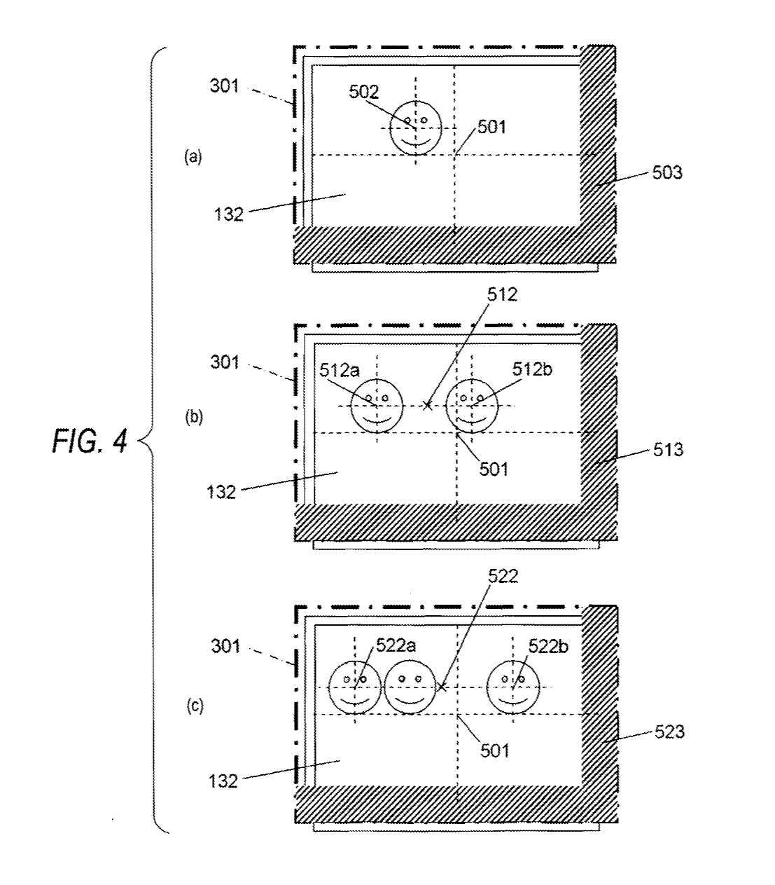

FIGS. 4(a) to 4(c) are diagrams showing an example of the relationship between the position of the face of the subject in the enlarged image 301 and a truncated region of image data. As shown in FIG. 4(a), if the face of one subject is detected in the enlarged image 301, the image processing section 131 determines a region where image data in the enlarged image 301 will be truncated such that the center point 502 of the face becomes close to the center 501 of the screen 132. In the example shown in FIG. 4(a), the image processing section 131 truncates image data of a shaded region 503 on the right and lower sides of the enlarged image 301.

As shown in FIG. 4(b), the image processing section 131 detects the faces of two subjects in the enlarged image. Next, the image processing section 131 determines a region where image data in the enlarged image 301 will be truncated such that a midpoint 512 of a line connecting the center points 512a and 512b of the faces becomes close to the center 501 of the screen 132. In the example shown in FIG. 4(b), the image processing section 131 truncates image data of a shaded region 513 on the right and lower sides of the enlarged image 301.

As shown in FIG. 4(c), the image processing section 131 detects the faces of three or more subjects in the enlarged image. Next, the image processing section 131 determines a region where image data in the enlarged image 301 will be truncated such that a midpoint 522 of a line connecting the center points 522a and 522b of two faces at both the left and right ends becomes close to the center 501 of the screen 132. In the example shown in FIG. 4(c), the image processing section 131 truncates image data of a shaded region 523 on the right and lower sides of the enlarged image 301.

As described above, the image processing section 131 determines a region where image data will be truncated such that the face of a subject detected by the face detection function becomes close to the center of the screen 132 of the display 130. Thus, the image processing section 131 can display the face of the subject close to the center of the display 130.

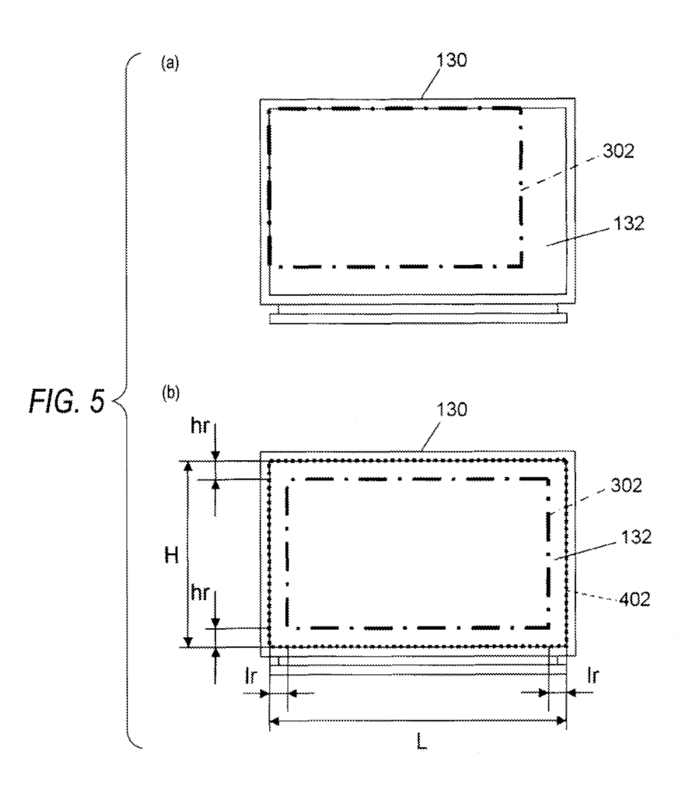

Next, image processing when the image enlargement and reduction section 129 reduces an image will be described. FIG. 5(a) is a diagram showing the size relationship between a reduced image and the screen of a display. FIG. 5(b) is a diagram showing the size relationship between a reduced image, a processed image, and the screen of a display.

If an image reduced by the image enlargement and reduction section 129 is displayed on the display 130, as shown in FIG. 5(a), there is a region where image data is missing on the screen 132 of the display 130. At this time, in this embodiment, the image processing section 131 adds null or single-color (for example, black) image data to the circumference of a reduced image 302 to adjust the image to the size of the screen 132 of the display 130. For example, as shown in FIG. 5(b), the image processing section 131 adds image data for hr pixels to the upper and lower sides of the reduced image 302, and adds image data for Ir pixels to the left and right sides of the reduced image 302. As a result, the reduced image 302 is in the center of the screen 132 of the display 130.

When the size of the screen 132 of the display 130 is “vertical H pixels×horizontal L pixels”, hr is expressed by Expression (5), and Ir is expressed by Expression (6). p is the above-described enlargement or reduction ratio.

$$\begin{matrix}[ Equation 5 ] & \\ hr = \frac{( 1 - p )}{2 H} & ( 5 ) \\ [ Equation 6 ] & \\ lr = \frac{( 1 - p )}{2 L} & ( 6 )\end{matrix}$$

A subject is not limited as being in the center of the image. As described above, if image data is truncated evenly from the upper and lower sides or from the left and right sides, there is a case where the subject is displayed to be deviated from the center of the display 130. Thus, the image processing section 131 may determine a region where image data will be added to the reduced image 302 in accordance with the position of the face in the reduced image detected by the face detection function.

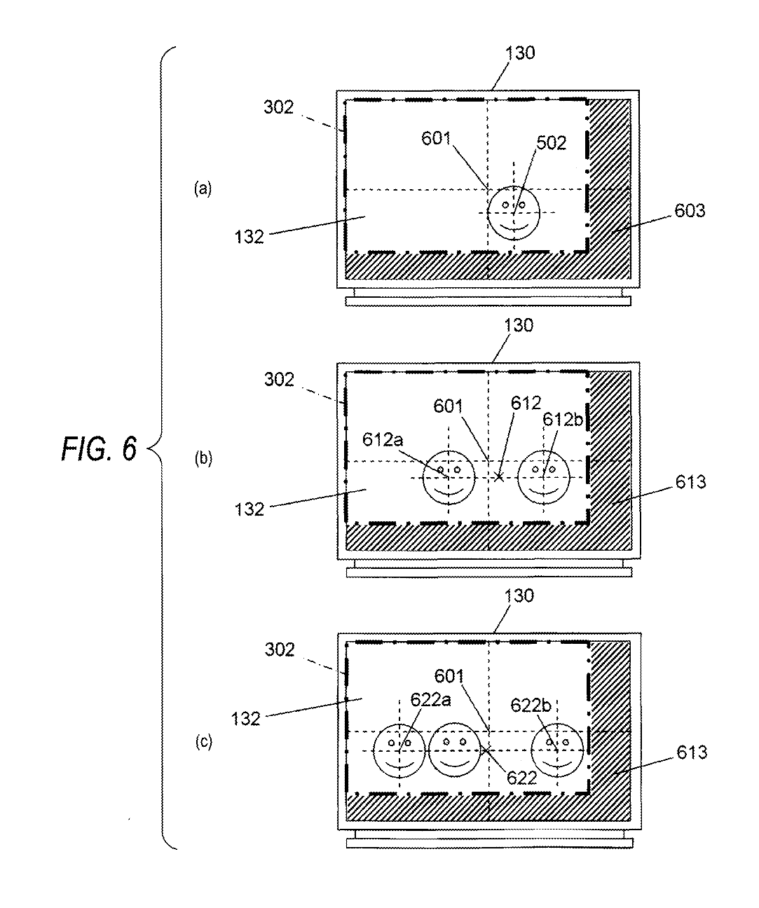

FIGS. 6(a) to 6(c) are diagrams showing an example of the relationship between the position of the face of a subject in the reduced image 302 and an added region of image data. As shown in FIG. 6(a), if the face of one subject is detected in the reduced image 302, the image processing section 131 determines a region where image data will be added to the reduced image 302 such that the center point 602 of the face becomes close to the center 601 of the screen 132. In the example shown in FIG. 6(a), the image processing section 131 adds image data to a shaded region 603 on the right and lower sides of the reduced image 302.

As shown in FIG. 6(b), the image processing section 131 detects the faces of two subjects in the reduced image. Next, the image processing section 131 determines a region where image data will be added to the reduced image 302 such that a midpoint 612 of a line connecting the center points 612a and 612b of the faces becomes close to the center 601 of the screen 132. In the example shown in FIG. 6(b), the image processing section 131 adds image data to a shaded region 613 on the right and lower sides of the reduced image 302.

As shown in FIG. 6(c), the image processing section 131 detects the faces of three or more subjects in the reduced image. Next, the image processing section 131 determines a region where image data will be added to the reduced image 302 such that a midpoint 622 of a line connecting the center points 622a and 622b of two faces at both the left and right ends becomes close to the center 601 of the screen 132. In the example shown in FIG. 6(c), the image processing section 131 adds image data to a shaded region 623 on the right and lower sides of the reduced image 302.

As described above, the image processing section 131 determines an added region of image data such that the face of the subject detected by the face detection function becomes close to the center of the screen 132 of the display 130. Thus, the image processing section 131 can display the face of the subject close to the center of the display 130.

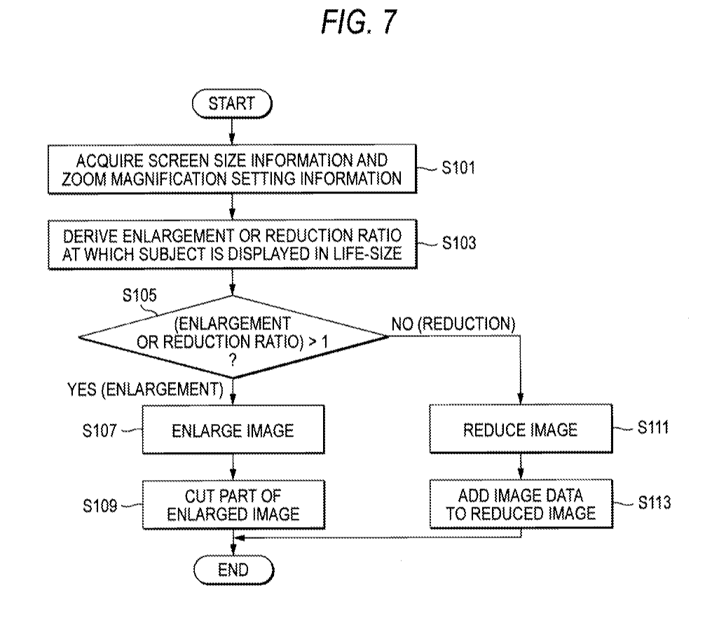

FIG. 7 is a flowchart showing an operation when the teleconferencing device 100 shown in FIG. 2 displays an image on the display 130. As shown in FIG. 7, the image enlargement and reduction ratio derivation section 127 acquires the screen size information of the display 130 and the zoom magnification setting information received by the zoom magnification setting receiving section 125 (Step S101). Next, the image enlargement and reduction ratio derivation section 127 derives an enlargement or reduction ratio for converting a subject of image data sent from the image decoding section 119 to have a size to be displayed on the display 130 of the host base in life-size (Step S103).

The image enlargement and reduction section 129 compares the enlargement or reduction ratio derived in Step S103 with 1 to determines whether to enlarge or reduce the image (S105). When the enlargement or reduction ratio is greater than 1, the image enlargement and reduction section 129 progresses to Step S107, and enlarges the image of image data sent from the image decoding section 119 on the basis of the enlargement or reduction ratio (S107). Next, the image processing section 131 truncates at least a part of the circumference of the enlarged image to adjust the image to the size of the screen 132 of the display 130 (S109).

When the enlargement or reduction ratio is smaller than 1, the image enlargement and reduction section 129 progresses to Step S111, and reduces the image of image data sent from the image decoding section 119 on the basis of the enlargement or reduction ratio (S111). Next, the image processing section 131 adds image data to at least a part of the circumference of the reduced image to adjust the image to the size of the screen 132 of the display 130 (S113).

As described above, even when the displays installed in the bases constituting the teleconferencing system of this embodiment are different in size, the image of the subject captured by the camera of the corresponding base can be displayed on the display of the host base in life-size using the zoom magnification setting information sent from the corresponding base and the screen size information in the host base. That is, if the zoom magnification setting information of the corresponding base can be received, the teleconferencing device of the host base can display the subject captured by the camera of the corresponding base on the display of the host base in life-size. Therefore, the users can have a teleconference with realistic sensation such that all the users are present on the host base side.

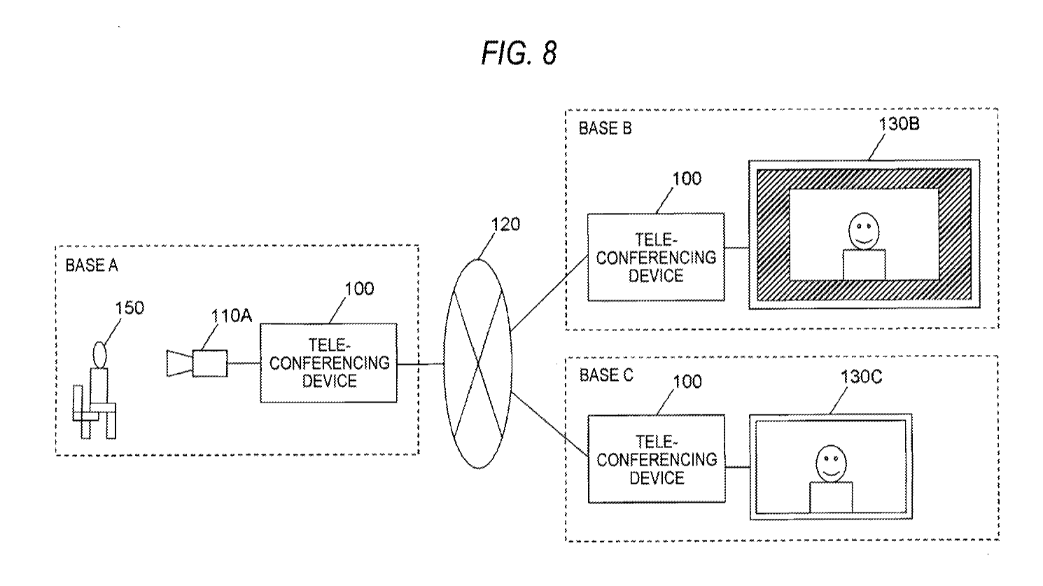

FIG. 8 shows a teleconferencing system in which teleconferencing devices 100 of three bases A to C are connected together through a network 120. In the teleconferencing system shown in FIG. 8, the screen size of a display 130B installed in the base B is different from the screen size of a display 130C installed in the base C. Even in the teleconferencing system shown in FIG. 8, according to the teleconferencing device 100 of this embodiment, a subject 150 captured by a camera 110A of the base A is displayed on the displays of the bases B and C in life-size.

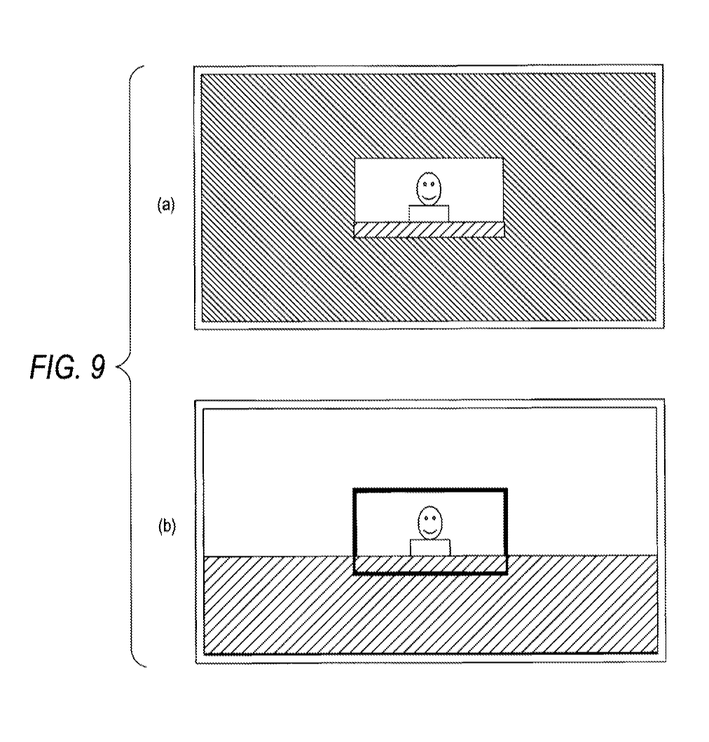

In recent years, a large-screen display, such as 103-inch or 150-inch, is available in the market. Thus, it is anticipated that such a display or a larger-screen display is used in a teleconferencing system. Even when such a large-screen display is used, if zoom magnification setting information sent from another base is “life-size in a 42-inch display”, as shown in FIG. 9(a), a region where nothing is displayed occupies most of the screen. For this reason, realistic sensation which can be obtained when a large-screen display is used may not be obtained.

In general, the viewing angle of a person is 100 degrees, and if an image is filled over the viewing angle of 100 degrees, it becomes possible to obtain realistic sensation as if something in the screen is in front of his/her eyes. Thus, the image processing section 131 may process image data to be added to the circumference of the image such that an image shown in FIG. 9(b) is obtained. In this case, the image processing section 131 has a function of segmenting an object, a person, a background, and the like in an image, and a function of extending a segment. An example of the segmentation method is described in PTL 2 (JP-A-10-302046).

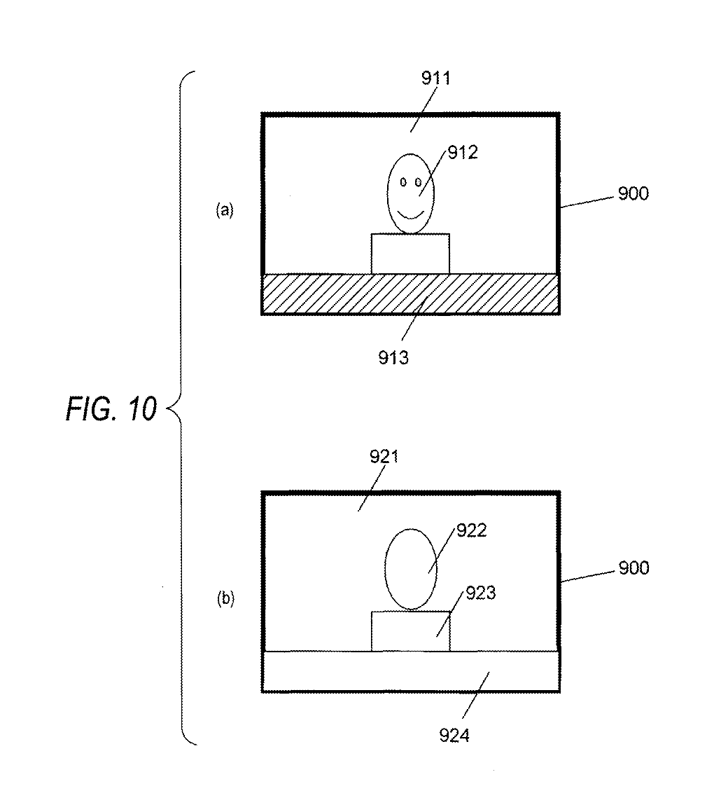

FIG. 10(a) is a diagram showing an example of an image. FIG. 10(b) is a diagram showing each region when the image of FIG. 10(a) is segmented. The image processing section 131 segments an image 900 shown in FIG. 10(a) including a background 911, a person 912, and a desk 913. Next, for example, as shown in FIG. 10(b), the image 900 is segmented into regions (segments) of a background 921, a head portion 922, a body portion 923, and a desk 924. The segmentation result differs depending on an algorithm or various settings. That is, the head portion 922 may be further segmented into minute regions, such as eyes, mouth, and hair. In the background 921, different regions may be recognized due to different colors or a difference in the degree of hit of light or illumination.

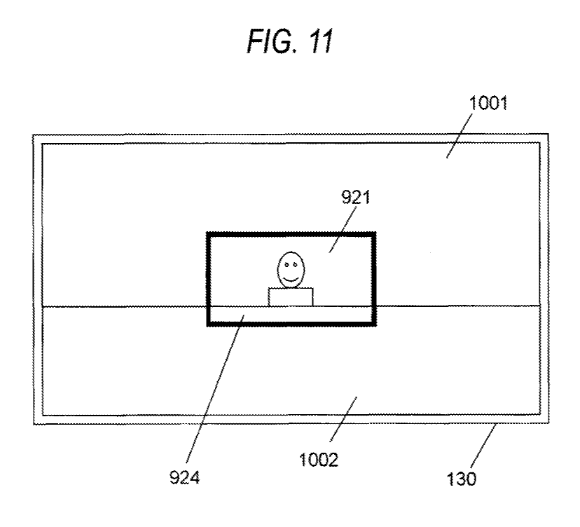

As shown in FIG. 10(b), there are two segments of the background portion 921 and the desk portion 924 on the circumference of the image 900. The image processing section 131 extends these segments to the screen end portion of the display 130. At this time, the image processing section 131 recognizes the pixel position with reference to the resolution (image resolution) of the image reduced by the image enlargement and reduction section 129 and the resolution (display resolution) of the display 130, and then extends the segments. Thus, in the example shown in FIG. 10, as shown in FIG. 11, the image processing section 131 sets an extended background portion 1001 extended from the background portion 921 and an extended desk portion 1002 extended from the desk portion 924. At this time, the background portion 921 and the extended background portion 1001, and the desk portion 924 and the extended desk portion 1002 become the same segment.

Finally, the image processing section 131 adds image data including texture information of the background portion 921 to the extended background portion 1001, and adds image data including texture information of the desk portion 924 to the extended desk portion 1002.

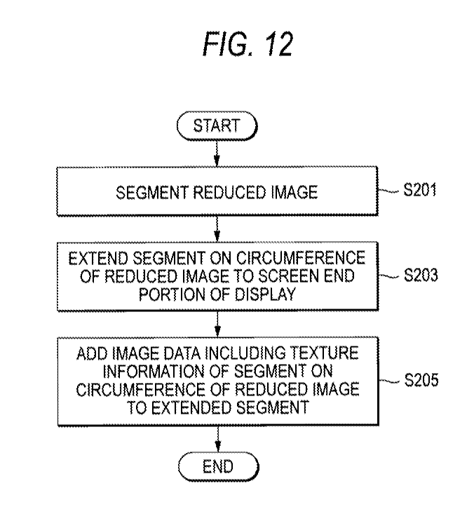

FIG. 12 is a flowchart showing the operation of the image processing section 131 described with reference to FIGS. 9 to 11. First, the image processing section 131 segments the reduced image obtained in Step S111 of FIG. 7 (S201). Next, the image processing section 131 extends a segment on the circumference of the reduced image to the screen end portion of the display 130 (S203). Finally, the image processing section 131 adds image data including texture information of the segment on the circumference of the reduced image to the extended segment (S205). This operation by the image processing section 131 is performed in Step S113 shown in FIG. 7.

The image processing section 131 performs the above-described process when a reduced image is displayed on a large-screen display 130, making is possible for a user to have a teleconference with higher realistic sensation without causing a sense of discomfort with respect to the viewing angle of a person.

Although the invention has been described in detail or with reference to a specific embodiment, it is obvious to those skilled in the art that various changes or modifications can be made without departing from the spirit and scope of the invention.

This application is based on Japanese Patent Application No. 2009-165922, filed Jul. 14, 2009, the content of which is incorporated herein by reference.

### INDUSTRIAL APPLICABILITY

The teleconferencing device according to the invention is useful as a teleconferencing device or the like which displays a subject captured by the camera of the corresponding base on the display of the host base in life-size.

### REFERENCE SIGNS LIST

100: teleconferencing device
110: camera
120: network
130: display
140: input device
111: image acquisition section
113: image encoding section
115: image transmitting section
117: image receiving section
119: image decoding section
121: zoom magnification setting acquisition section
123: zoom magnification setting transmitting section
125: zoom magnification setting receiving section
127: image enlargement and reduction ratio derivation section
129: image enlargement and reduction section
131: image processing section
133: image display control section

1. A teleconferencing device for a teleconferencing system which transmits and receives an image captured by a camera between a host base and at least one corresponding base, and displays the image on a display, the teleconferencing device comprising:
an image receiving section that receives an image transmitted from the corresponding base;
a zoom magnification setting receiving section that receives zoom magnification setting information of each camera provided in the corresponding base;
an image enlargement and reduction ratio derivation section that derives an enlargement or reduction ratio, at which each subject in the image captured by each camera of the corresponding base is displayed on the display provided in the host base in life-size, for each corresponding base on the basis of the zoom magnification setting information received by the zoom magnification setting receiving section and screen size information of the display provided in the host base;
an image enlargement and reduction section that enlarges or reduces the image transmitted from the corresponding base on the basis of the enlargement or reduction ratio; and
an image display control section that conducts a control to display the image from each corresponding base enlarged or reduced by the image enlargement and reduction section on the display of the host base.

2. The teleconferencing device according to claim 1, wherein the zoom magnification setting information is information representing a size of the subject to a size of the display.

3. The teleconferencing device according to claim 1, wherein the image enlargement and reduction ratio derivation section derives the enlargement or reduction ratio on the basis of the zoom magnification setting information received by the zoom magnification setting receiving section, the screen size information of the display of the host base, a resolution of the image received by the image receiving section, and a resolution of the display of the host base.

4. The teleconferencing device according to claim 1, further comprising:
an image processing section that detects a position of a face of the subject in the image enlarged by the image enlargement and reduction section, and truncates image data of a partial region of the enlarged image such that the face becomes close to a center of a screen of the display of the host base.

5. The teleconferencing device according to claim 1, further comprising:
an image processing section that detects a position of a face of the subject in the image reduced by the image enlargement and reduction section, and adds image data on a periphery of the reduced image such that the face becomes close to a center of a screen of the display of the host base.

6. The teleconferencing device according to claim 1, further comprising:
an image processing section that segments the image reduced by the image enlargement and reduction section, extends a circumferential segment on a circumference of the reduced image to a screen end portion of the display of the host base, and adds image data including texture information of the circumferential segment to an extended region.

7. The teleconferencing device according to claim 6, wherein the image processing section extends the circumferential segment in reference to a resolution of the reduced image and a resolution of the display of the host base.

8. An image display processing method which is executed by a teleconferencing device for a teleconferencing system which transmits and receives an image captured by a camera between a host base and at least one corresponding base and displays the image on a display, the method comprising:
receiving an image transmitted from the corresponding base;
receiving zoom magnification setting information of each camera provided in the corresponding base;
deriving an enlargement or reduction ratio, at which each subject in the image captured by each camera of the corresponding base is displayed on the display provided in the host base in life-size, for each corresponding base on the basis of the zoom magnification setting information and screen size information of the display provided in the host base;
enlarging or reducing the image transmitted from the corresponding base on the basis of the enlargement or reduction ratio; and
conducting a control to display the enlarged or reduced image from each corresponding base on the display of the host base.
